(19) United States
(12) Patent Application Publication
(10) Pub. No.: US 2025/0265912 A1
(43) Pub. Date: Aug. 21, 2025

(54) ELECTRONIC DEVICE FOR OUTPUTTING HAPTIC FEEDBACK AND METHOD THEREOF

(71) Applicants: Samsung Electronics Co., Ltd., Suwon-si (KR); Seoul National University R&DB Foundation, Seoul (KR)

(72) Inventors: Jaehwan LEE, Suwon-si (KR); Hyunchul WOO, Suwon-si (KR); Hyungjoo YIM, Suwon-si (KR); Dongjun LEE, Seoul (KR); Youngseon LEE, Seoul (KR); Seunghwan KO, Seoul (KR); Hyunsu KIM, Seoul (KR); Cheolmin LEE, Seoul (KR); Jinuk HEO, Seoul (KR)

(21) Appl. No.: 19/197,229

(22) Filed: May 2, 2025

Related U.S. Application Data
(63) Continuation of application No. PCT/KR2023/015890, filed on Oct. 14, 2023.

(30) Foreign Application Priority Data
Nov. 10, 2022 (KR) 10-2022-0149973
Nov. 16, 2022 (KR) 10-2022-0154009

(51) Int. Cl. G08B 6/00; H05B 1/02

(52) U.S. Cl. CPC G08B 6/00; H05B 1/0272

(57) ABSTRACT

An electronic device according to an embodiment may receive haptic data from an external electronic device through a communication circuit. The electronic device may control a plurality of heating elements based on an orientation indicated by the haptic data. The electronic device may control a plurality of vibration actuators based on the orientation and the timing at which the plurality of heating elements are controlled.

### CROSS-REFERENCE TO RELATED APPLICATIONS

This application is a International Application No. PCT/KR2023/015890 designating the United States, filed on Oct. 14, 2023, in the Korean Intellectual Property Receiving Office and claiming priority to Korean Patent Application Nos. 10-2022-0149973, filed on Nov. 10, 2022, and 10-2022-0154009, filed on Nov. 16, 2022, in the Korean Intellectual Property Office, the disclosures of each of which are incorporated by reference herein in their entireties.

### BACKGROUND

### Field

The disclosure relates to an electronic device for outputting haptic feedback and a method thereof.

### Description of Related Art

An electronic device may output media content. In a state of outputting media content, electronic devices for reinforcing a user experience are being developed.

### SUMMARY

According to an example embodiment, an electronic device may comprise: communication circuitry, a housing comprising a surface in which a plurality of heating elements and a plurality of haptic actuators are arranged, and at least one processor, comprising processing circuitry, coupled to the plurality of heating elements and the plurality of haptic actuators arranged on the surface. At least one processor, individually and/or collectively, may be configured to cause the electronic device to: receive, from an external electronic device through the communication circuitry, haptic data; sequentially control, based on an orientation indicated by the haptic data, the plurality of heating elements; and sequentially control, based on the orientation and timings at which the plurality of heating elements are controlled, the plurality of haptic actuators.

According to an example embodiment, a method of an electronic device may comprise: receiving, from an external electronic device through communication circuitry, haptic data; sequentially controlling, based on an orientation indicated by the haptic data, a plurality of heating elements; and sequentially controlling, based on the orientation and timings at which the plurality of heating elements are controlled, a plurality of haptic actuators.

According to an example embodiment, a non-transitory computer-readable storage medium storing one or more programs, the one or more programs may, when executed by at least one processor, comprising processing circuitry, individually and/or collectively, of an electronic device, cause the electronic device to perform operations comprising: receiving, from an external electronic device through communication circuitry, haptic data; sequentially control, based on an orientation indicated by the haptic data, a plurality of heating elements; and sequentially control, based on the orientation and timings at which the plurality of heating elements are controlled, a plurality of haptic actuators.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1A is a block diagram illustrating an example configuration of an electronic device and an external electronic device according to various embodiments;

FIG. 1B is a block diagram illustrating an example configuration of an electronic device according to various embodiments;

FIG. 2 is a diagram illustrating an example of a heating element and a haptic actuator arranged on a surface of a housing according to various embodiments;

FIG. 3 is a diagram illustrating an example of media content for obtaining haptic data, according to various embodiments;

FIG. 4 is a diagram including graphs illustrating an example of an electronic device that outputs haptic data according to various embodiments;

FIG. 5 is a diagram illustrating an example of haptic data according to various embodiments;

FIG. 6 is a flowchart illustrating an example operation of an electronic device according to various embodiments; and

FIG. 7 is a flowchart illustrating an example operation of an electronic device according to various embodiments.

### DETAILED DESCRIPTION

Hereinafter, various example embodiments of the present disclosure will be described in greater detail with reference to the accompanying drawings.

The various example embodiments of the present disclosure and terms used herein are not intended to limit the technology described in the present disclosure to specific embodiments, and should be understood to include various modifications, equivalents, or substitutes of the corresponding embodiment. In relation to the description of the drawings, a reference numeral may be used for a similar component. A singular expression may include a plural expression unless it is clearly meant differently in the context. In the present disclosure, an expression such as “A or B”, “at least one of A and/or B”, “A, B or C”, or “at least one of A, B and/or C”, and the like may include all possible combinations of items listed together. Expressions such as “1st”, “2nd”, “first” or “second”, and the like may modify the corresponding components regardless of order or importance, is simply used to distinguish one component from another component, but does not limit the corresponding components. When a (e.g., first) component is referred to as “connected (functionally or communicatively)” or “accessed” to another (e.g., second) component, the component may be directly connected to the other component or may be connected through another component (e.g., a third component).

The term “module” used in the present disclosure may include a unit configured with hardware, software, or firmware, or any combination thereof, and may be used interchangeably with terms such as logic, logic block, component, or circuit, and the like. The module may be an integrally configured component or a minimum unit or part thereof that performs one or more functions. For example, a module may be configured with an application-specific integrated circuit (ASIC).

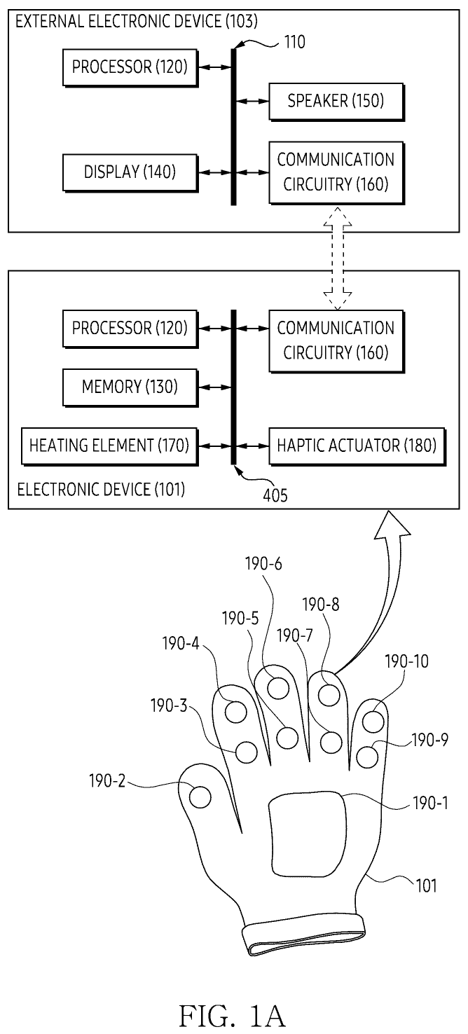

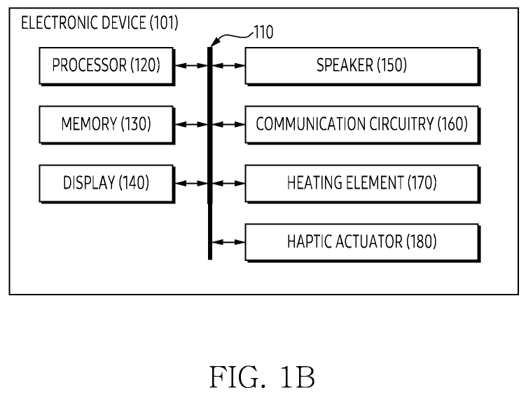

FIG. 1A is a block diagram illustrating an example configuration of an electronic device and an external electronic device according to various embodiments. FIG. 1B is a block diagram illustrating an example configuration of an electronic device according to various embodiments. An electronic device 101 of FIG. 1A and/or FIG. 1B may be in a form wearable by a user. For example, the electronic device 101 of FIG. 1A and/or FIG. 1B may include a form such as clothing, such as a glove, a vest, a shirt, or pants. The electronic device 101 of FIG. 1A and/or FIG. 1B may have a form such as a patch. The electronic device 101 in a form of the patch may be used in a state of being attached on an external electronic device 103. In an embodiment to be described later, the electronic device 101 is illustrated in a form of a glove, but is not limited thereto. The external electronic device 103 of FIG. 1A may include a terminal owned by a user. For example, the terminal may include a personal computer (PC) such as a laptop or desktop, a smartphone, a smart pad, a tablet PC, a smartwatch, and a smart accessory such as a head-mounted device (HMD). For example, the terminal may include a device for augmented reality (AR) such as an AR glass. For example, the terminal may include a device for virtual reality (VR), extended reality (XR), and/or mixed reality (MR).

Referring to FIGS. 1A and/or 1B, according to an embodiment, the electronic device 101 may include at least one of a processor (e.g., including processing circuitry) 120, a memory 130, a display 140, communication circuitry 160, a heating element (refer to FIG. 1B) 170, and/or a haptic actuator (e.g., including haptic circuitry) 180 (refer to FIG. 1B). The processor 120, the memory 130, the communication circuitry 160, the heating element 170, and the haptic actuator 180 may be electronically and/or operably coupled with each other by an electronical component such as a communication bus 110. Hereinafter, hardware being operably coupled may refer, for example, to a direct connection or indirect connection between hardware being established by wire or wirelessly so that the second hardware is controlled by the first hardware among the hardware. Although illustrated in different blocks, the various embodiment is not limited thereto. Some of the hardware of FIG. 1A and/or FIG. 1B (e.g., the processor 120, the memory 130, and the communication circuitry 160) may be included in a single integrated circuit, such as a system on a chip (SoC). A type and/or number of hardware included in the electronic device 101 is not limited to those illustrated in FIG. 1A and/or 1B. For example, the electronic device 101 may include only some of the hardware illustrated in FIG. 1A and/or 1B.

According to an embodiment, the electronic device 101 and/or the external electronic device 103 may include hardware for processing one or more data. The hardware for processing data may include, for example, an arithmetic and logic unit (ALU), a floating point unit (FPU), a field programmable gate array (FPGA), a central processing unit (CPU), and/or an application processor (AP). The processor 120 may have a structure of a single core processor, or may have a structure of a multi core processor, such as a dual core, a quad core, a hexa core, or an octa core. Thus, the processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The memory 130 of the electronic device 101 may include a hardware component for storing data and/or instructions inputted to and/or output from the processor 120 of the electronic device 101. For example, the memory 130 may include volatile memory, such as random-access memory (RAM), and/or non-volatile memory, such as read-only memory (ROM). For example, the volatile memory may include at least one of a dynamic RAM (DRAM), a static RAM (SRAM), a cache RAM, and a pseudo SRAM (PSRAM). For example, the non-volatile memory may include at least one of a programmable ROM (PROM), an erasable PROM (EPROM), an electrically erasable PROM (EEPROM), a flash memory, a hard disk, a compact disk, a solid state drive (SSD), and an embedded multi-media card (eMMC). For example, the electronic device 101 may identify haptic information stored in the memory 130. For example, the haptic information may be associated with haptic data transmitted from the external electronic device 103. For example, the haptic information may include information for controlling a plurality of heating elements including the heating element 170 and a plurality of haptic actuators including the haptic actuator 180. For example, the haptic information may include information for controlling the plurality of heating elements and the plurality of haptic actuators in a preset order. However, the disclosure is not limited thereto.

According to an embodiment, the display 140 of the external electronic device 103 may output visualized information to the user. For example, the display 140 may be controlled by the processor 120 including a circuit such as a graphic processing unit (GPU) to output visualized information to the user. The display 140 may include, for example, and without limitation, a flat panel display (FPD) and/or an electronic paper. The FPD may include a liquid crystal display (LCD), a plasma display panel (PDP), and/or one or more light emitting diodes (LEDs). The LED may include organic LED (OLED). For example, the external electronic device 103 may output media content using the display 140.

According to an embodiment, the speaker 150 of the external electronic device 103 may include at least one voice coil that provides vibration to a diaphragm within the speaker 150, and a magnet capable of forming a magnetic field. When a current flows through the at least one voice coil, the magnetic field formed by the voice coil may vibrate the voice coil by interacting with the magnetic field formed by the magnet. The diaphragm connected to the voice coil may vibrate based on the vibration of the voice coil. The speaker 150 may output an audio signal based on the vibration of the diaphragm. For example, the external electronic device 103 may output media content using the speaker 150.

According to an embodiment, the communication circuitry 160 of the electronic device 101 may include a hardware component for supporting transmission and/or reception of an electrical signal between the electronic device 101 and the external electronic device 103. The communication circuitry 160 may include a hardware component for supporting transmission and/or reception of an electrical signal between the electronic device 101 and the external electronic device 103. For example, the communication circuitry 160 may include at least one of a MODEM, an antenna, and an optic/electronic (O/E) converter. The communication circuitry 160 may support transmission and/or reception of an electrical signal based on various types of protocols such as Ethernet, a local area network (LAN), a wide area network (WAN), wireless fidelity (Wi-Fi), Bluetooth, Bluetooth low energy (BLE), ZigBee, long term evolution (LTE), and 5th generation new radio (5G NR).

For example, the communication circuitry 160 may include a high definition multimedia interface (HDMI), a universal serial bus (USB) interface, SD card interface, or audio interface in association with a terminal such as an HDMI connector, a USB connector, an SD card connector, or an audio connector. The electronic device 101 may be electronically and/or operably connected with the external electronic device 103 based on the above examples.

According to an embodiment, the electronic device 101 may include a heating element 170. The electronic device 101 may control the heating element 170 based on haptic data transmitted from the external electronic device 103. The electronic device 101 may adjust a current and/or a voltage for controlling the heating element 170. The electronic device 101 may control a temperature of the heating element 170 based on adjusting of the current and/or the voltage. For example, the heating element 170 may include a Peltier element. For example, the heating element 170 may change a temperature based on a Peltier effect. For example, the Peltier effect may be an effect that causes a change in a temperature by utilizing movement of heat generated by a flow of currents.

According to an embodiment, the electronic device 101 may include a haptic actuator 180. For example, the haptic actuator 180 may include various circuitry including, for example, a piezoelectric element. The electronic device 101 may control the haptic actuator 180 based on haptic data transmitted from the external electronic device 103. The electronic device 101 may adjust a current and/or a voltage for controlling the haptic actuator 180. The electronic device 101 may adjust the intensity of a vibration generated by the haptic actuator 180, based on adjusting the current and/or the voltage.

According to an embodiment, the electronic device 101 may receive haptic data from the external electronic device 103 through the communication circuitry 160. The haptic data may include data for controlling the heating element 170 and/or the haptic actuator 180 of the electronic device 101. The electronic device 101 may control the heating element 170 and/or the haptic actuator 180, which are arranged on a surface of a housing of the electronic device 101, based on receiving the haptic data. For example, the electronic device 101 may identify an orientation indicated by the haptic data. For example, the electronic device 101 may control the heating element 170 and/or the haptic actuator 180 based on the indicated orientation. The electronic device 101 may control the haptic actuator 180 based on the orientation and a timing at which the heating element is controlled. The electronic device 101 may control the heating element 170 and the haptic actuator 180 at substantially the same timing. According to an embodiment, the electronic device 101 may control a plurality of haptic actuators based on controlling a plurality of heating elements. The electronic device 101 may identify a temperature of a first heating element among the plurality of heating elements. The electronic device 101 may control a first haptic actuator corresponding to the first heating element based on identifying the first heating element, which is a preset temperature. However, the disclosure is not limited thereto.

According to an embodiment, the electronic device 101 may include a housing including a surface in which a plurality of heating elements and a plurality of haptic actuators are arranged. The electronic device 101 may include a plurality of heating elements and a plurality of haptic actuators to be arranged on a surface of a housing. The electronic device 101 may include a processor 120 connected to the plurality of heating elements and the plurality of haptic actuators arranged on the surface. However, the disclosure is not limited thereto.

According to an embodiment, the electronic device 101 may receive haptic data from the external electronic device 103 through the communication circuitry 160. For example, the haptic data may include information for controlling the heating element 170 or the haptic actuator 180. For example, the haptic data may include information associated with a position (or range) where the plurality of heating elements and the plurality of haptic actuators are controlled. For example, the haptic data may include information associated with an orientation for indicating the plurality of heating elements and the plurality of haptic actuators. For example, the haptic data may include information for changing a temperature of the heating element 170 to a preset temperature. For example, the haptic data may include information for changing the temperature of the heating element 170 within a preset time. An operation for changing the temperature of the heating element 170 to the preset temperature may be related to a current transmitted to the heating element 170 or a voltage applied to the heating element 170. For example, the haptic data may include information for controlling a vibration of the haptic actuator 180. For example, the haptic data may include information for adjusting a vibration intensity of the haptic actuator 180. For example, the haptic data may include information for representing texture, based on the haptic actuator 180. However, the disclosure is not limited thereto.

According to an embodiment, the electronic device 101 may include a plurality of heating elements and a plurality of haptic actuators arranged on a surface of a housing. For example, the plurality of heating elements and the plurality of haptic actuators may be disposed on areas 190-1, 190-2, 290-3, 190-4, 190-5, 190-6, 190-7, 190-8, 190-9 and 190-10 (which may be referred to as areas 190-1 to 190-10) illustrated in FIG. 1. The areas are an example, and areas in which the plurality of heating elements and the plurality of haptic actuators are arranged are not limited. For example, the plurality of heating elements and the plurality of haptic actuators may be disposed on a first area 190-1 to a tenth area 190-10. According to an embodiment, the electronic device 101 may control the plurality of heating elements and/or the plurality of haptic actuators arranged on the areas. For example, the electronic device 101 may control the plurality of heating elements and the plurality of haptic actuators based on haptic data transmitted from the external electronic device 103. For example, the haptic data may include first haptic data for controlling the plurality of heating elements. For example, the haptic data may include second haptic data for controlling the plurality of haptic actuators. For example, the electronic device 101 may control the plurality of heating elements and the plurality of haptic actuators of a preset area, based on the haptic data. For example, the electronic device 101 may sequentially output haptic feedback from a fourth area 190-4 to a third area 190-3. For example, the electronic device 101 may output haptic feedback based on the plurality of heating elements and the plurality of haptic actuators arranged on the fourth area 190-4. For example, the electronic device 101 may output haptic feedback using the plurality of heating elements and the plurality of haptic actuators arranged on the third area 190-3, based on outputting the haptic feedback on the fourth area 190-4. The above-described example is an example of sequentially outputting haptic feedback, and the orientation and/or order in which the haptic feedback is output is not limited.

As described above, according to an embodiment, the electronic device 101 may receive haptic data from the external electronic device 103. The electronic device 101 may identify an orientation included in the haptic data and indicated by the haptic data. The electronic device 101 may sequentially control the plurality of heating elements, based on the orientation indicated by the haptic data. The electronic device 101 may sequentially control the plurality of haptic actuators based on the orientation and timings at which the plurality of heating elements is sequentially controlled. The electronic device 101 may sequentially control the plurality of heating elements and the plurality of haptic actuators arranged on a surface of a housing. The electronic device 101 may provide, to a user of the electronic device 101, complex haptic feedback, by sequentially controlling the plurality of heating elements and the plurality of haptic actuators. The electronic device 101 may enhance a user experience of the electronic device 101 by providing the complex haptic feedback. The electronic device 101 may sequentially control the plurality of heating elements and the plurality of haptic actuators, based on the orientation, but the disclosure is not limited thereto. The electronic device 101 may provide, to a user of the electronic device 101, realistic haptic feedback, by providing the haptic feedback based on directionality.

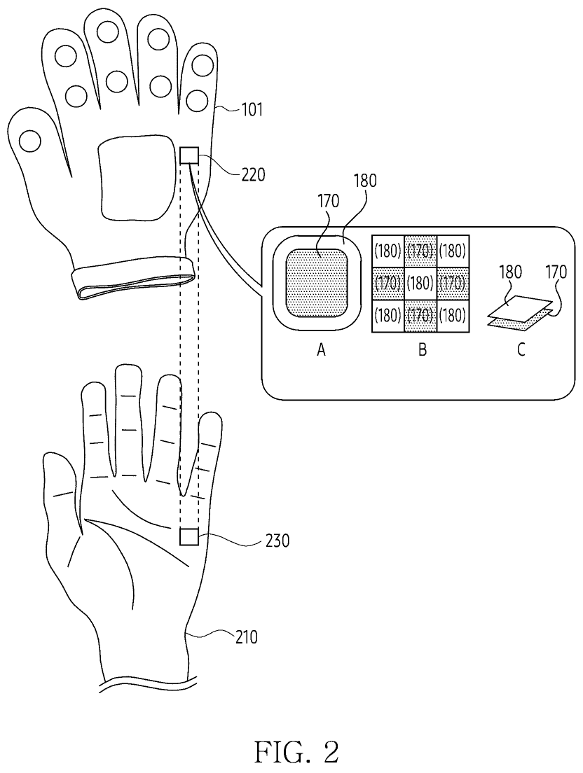

FIG. 2 is a diagram illustrating an example of a heating element and a haptic actuator arranged on a surface of a housing according to various embodiments. An electronic device 101 of FIG. 2 may be an example of the electronic device 101 of FIG. 1A and/or FIG. 1B. Operations of FIG. 2 may be executed by the processor 120 of FIG. 1A and/or FIG. 1B.

Referring to FIG. 2, according to an embodiment, the electronic device 101 may be in a form of being worn on a preset body of a user 210 of the electronic device 101. For example, the body of the user 210 may include a hand of the user 210. According to an embodiment, the electronic device 101 may include a plurality of heating elements (e.g., the heating element 170 of FIG. 1A and/or FIG. 1B) and a plurality of haptic actuators (e.g., the haptic actuator 180 of FIG. 1A and/or FIG. 1B), which are arranged on a surface of a housing. The electronic device 101 may control the plurality of heating elements and the plurality of haptic actuators based on haptic data transmitted from an external electronic device (e.g., the external electronic device 103 of FIG. 1A).

For example, the plurality of heating elements and the plurality of haptic actuators may be arranged as in cases A, B, and C. For example, in case A, a haptic actuator 180 may be arranged in a form surrounding a heating element 170. For example, the haptic actuator 180 may be disposed less than a preset distance apart from the heating element 170. For example, the haptic actuator 180 may be disposed in contact with the heating element 170. For example, in case B, the heating element 170 and the haptic actuator 180 may be arranged in a grid pattern. For example, each surface forming the haptic actuator 180 may be adjacent to the heating elements 170. For example, in case C, the heating element 170 and the haptic actuator 180 may be arranged to overlap. For example, a surface forming the haptic actuator 180 may be arranged to face a surface forming the heating element 170. In the above-described cases A, B, and C, the heating element 170 and the haptic actuator 180 are illustrated as singular, but may be plural. However, the disclosure is not limited thereto.

According to an embodiment, the electronic device 101 may control a plurality of heating elements and a plurality of haptic actuators arranged on an area 220. The area 220 may be matched to a part 230 of the body of the user 210. For example, the electronic device 101 may output haptic feedback to the part 230 of the body of the user 210, based on controlling the plurality of heating elements and the plurality of haptic actuators arranged on the area 220.

According to an embodiment, in the electronic device 101, the plurality of heating elements and the plurality of haptic actuators may be arranged to overlap, such as the case C. In a state that the plurality of heating elements and the plurality of haptic actuators are arranged to overlap, the electronic device 101 may change haptic data transmitted from an external electronic device. For example, when the plurality of heating elements is located at a relatively farther distance than the plurality of haptic actuators, the electronic device 101 may change haptic data. For example, when the plurality of heating elements is arranged at a relatively farther distance from the body of the user 210 than the plurality of haptic actuators, the electronic device 101 may output more strongly haptic feedback output by the plurality of heating elements. For example, the haptic feedback output by the plurality of heating elements may include generating heat. For example, when the plurality of haptic actuators is arranged at a relatively farther distance from the body of the user 210 than the plurality of heating elements, the electronic device 101 may output more strongly the haptic feedback output by the plurality of haptic actuators. For example, the haptic feedback may include vibration feedback generated by haptic actuators.

As described above, the electronic device 101 may receive haptic data from an external electronic device. The electronic device 101 may output haptic feedback associated with the haptic data based on receiving the haptic data. For example, the electronic device 101 may output the haptic feedback based on a plurality of heating elements and a plurality of haptic actuators. The electronic device 101 may change haptic data based on an arrangement of the plurality of heating elements and the plurality of haptic actuators. The electronic device 101 may output haptic feedback based on the changed haptic data. The electronic device 101 may enhance an experience of the user 210 of the electronic device 101 by outputting the haptic data based on the changed haptic data.

According to an embodiment, the electronic device 101 may include a plurality of heating elements including a first heating element and a second heating element. The electronic device 101 may include a first haptic actuator corresponding to the first heating element and a second haptic actuator corresponding to the second heating element. The electronic device 101 may at least temporarily cease to control the plurality of heating elements among the plurality of heating elements and the plurality of haptic actuators. In a state of ceasing to control the plurality of heating elements, the electronic device 101 may control a plurality of haptic actuators corresponding to the plurality of heating elements. The electronic device 101 may output haptic feedback and/or vibration feedback, based on controlling the plurality of haptic actuators. The electronic device 101 may output haptic feedback using a plurality of haptic actuators corresponding to the plurality of heating elements of which the controlling is ceased.

As described above, according to an embodiment, in a state of at least temporarily ceasing to control the plurality of heating elements, the electronic device 101 may control the plurality of haptic actuators corresponding to the plurality of heating elements of which the controlling is ceased. In a state of at least temporarily ceasing to control the plurality of heating elements, the electronic device 101 may output haptic feedback and/or vibration feedback based on a plurality of haptic actuators corresponding to the plurality of heating elements. In a state of at least temporarily ceasing to control the plurality of heating elements, the electronic device 101 may provide a continuous sense of warmth to the user of the electronic device 101, by controlling the plurality of haptic actuators to output haptic feedback and/or vibration feedback.

According to an embodiment, the electronic device 101 may control a first heating element among a plurality of heating elements disposed on the area 220. The electronic device 101 may control a first haptic actuator corresponding to the first heating element while controlling the first heating element. The electronic device 101 may control a second heating element different from the first heating element. The electronic device 101 may at least temporarily cease to control a second haptic actuator, different from the first haptic actuator, corresponding to the second heating element, while controlling the second heating element. For example, the electronic device 101 may control the first haptic actuator among the first haptic actuator and the second haptic actuator, while controlling the first heating element and the second heating element.

As described above, according to an embodiment, the electronic device 101 may include a first heating element, a second heating element, a first haptic actuator corresponding to the first heating element, and a second haptic actuator corresponding to the second heating element. The electronic device 101 may control the first heating element among the first heating element and the second heating element. The electronic device 101 may at least temporarily cease to control the second haptic actuator, while controlling the first heating element, the second heating element, and the first haptic actuator. The electronic device 101 may generate a sense of warmth on an area corresponding to the first heating element and the first haptic actuator, by controlling the first haptic actuator corresponding to the first heating element.

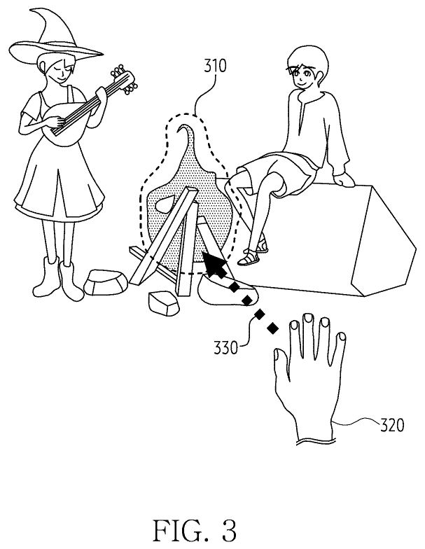

FIG. 3 is a diagram illustrating an example of media content for obtaining haptic data, according to various embodiments. An electronic device 101 of FIG. 3 may include the electronic device 101 of FIG. 1A, 1B, and/or FIG. 2. Operations of FIG. 3 may be executed by the processor 120 of FIG. 1A and/or 1B.

Referring to FIG. 3, the electronic device 101 according to an embodiment may output haptic feedback based on haptic data transmitted from an external electronic device (e.g., the external electronic device 103 of FIG. 1A). FIG. 3 may be an example of obtaining haptic feedback from media content executed by an external electronic device. For example, the media content may include a software application executed by the external electronic device. For example, the electronic device 101 may be connected to the external electronic device through communication circuitry (e.g., the communication circuitry 160 of FIG. 1A) while executing the media content. The electronic device 101 may control a first virtual object 320 displayed in the media content, in a state of being connected to the external electronic device through the communication circuitry. For example, the first virtual object 320 may be controlled by the electronic device 101 or controlled by a controller of the external electronic device.

According to an embodiment, the external electronic device may identify a second virtual object 310 included in media content while displaying the media content. For example, the second virtual object 310 may include an object capable of changing a temperature, such as a bonfire. For example, the external electronic device may identify movement of the first virtual object 320. For example, the external electronic device may identify that the first virtual object 320 moves in an orientation 330 approaching the second virtual object 310. For example, the external electronic device may obtain haptic data based on movement of the first virtual object 320. For example, the external electronic device may obtain haptic data for controlling a plurality of heating elements and a plurality of haptic actuators included in the electronic device 101, based on the movement of the first virtual object 320.

According to an embodiment, the electronic device 101 may receive haptic data obtained based on the movement of the first virtual object 320. The electronic device 101 may control the plurality of heating elements and the plurality of haptic actuators based on receiving the haptic data. For example, as the first virtual object 320 approaches the second virtual object 310, the electronic device 101 may output stronger heat using the plurality of heating elements. For example, as the first virtual object 320 approaches the second virtual object 310, the electronic device 101 may generate a stronger vibration using the plurality of haptic actuators. For example, as the first virtual object 320 approaches the second virtual object 310, the electronic device 101 may output stronger haptic feedback using the plurality of heating elements and the plurality of haptic actuators. For example, the electronic device 101 may output stronger haptic feedback by transmitting more current to the plurality of heating elements and the plurality of haptic actuators.

According to an embodiment, the electronic device 101 may receive haptic data obtained based on the thumb of the first virtual object 320 approaching the second virtual object 310. The electronic device 101 may control a plurality of heating elements disposed on an area matching the thumb of a user (e.g., the user 210 of FIG. 2) of the electronic device 101, based on receiving the haptic data. The electronic device 101 may control a plurality of heating elements disposed on a first area matching the thumb of the user. The electronic device 101 may control a plurality of heating elements disposed on a second area different from the first area, based on controlling the plurality of heating elements disposed on the first area. For example, the second area may include an area corresponding to the little finger of the user. The electronic device 101 may sequentially control a plurality of heating elements disposed between the first area and the second area. The electronic device 101 may control a plurality of haptic actuators based on a timing of controlling the plurality of heating elements. The electronic device 101 may control the plurality of haptic actuators at substantially the same timing as the plurality of heating elements. For example, the electronic device 101 may control the plurality of haptic actuators corresponding to the plurality of heating elements, based on the timing. The electronic device 101 may output haptic feedback using the plurality of heating elements and the plurality of haptic actuators at substantially the same timing.

As described above, according to an embodiment, the electronic device 101 may receive haptic data obtained based on the first virtual object 320 included in media content. The electronic device 101 may output haptic feedback based on receiving the haptic data. The electronic device 101 may control a plurality of heating elements and a plurality of haptic actuators based on receiving the haptic data. The electronic device 101 may control the plurality of heating elements and the plurality of haptic actuators at substantially the same timing. The electronic device 101 may enhance a user experience of the electronic device 101 by controlling the plurality of heating elements and the plurality of haptic actuators at substantially the same timing.

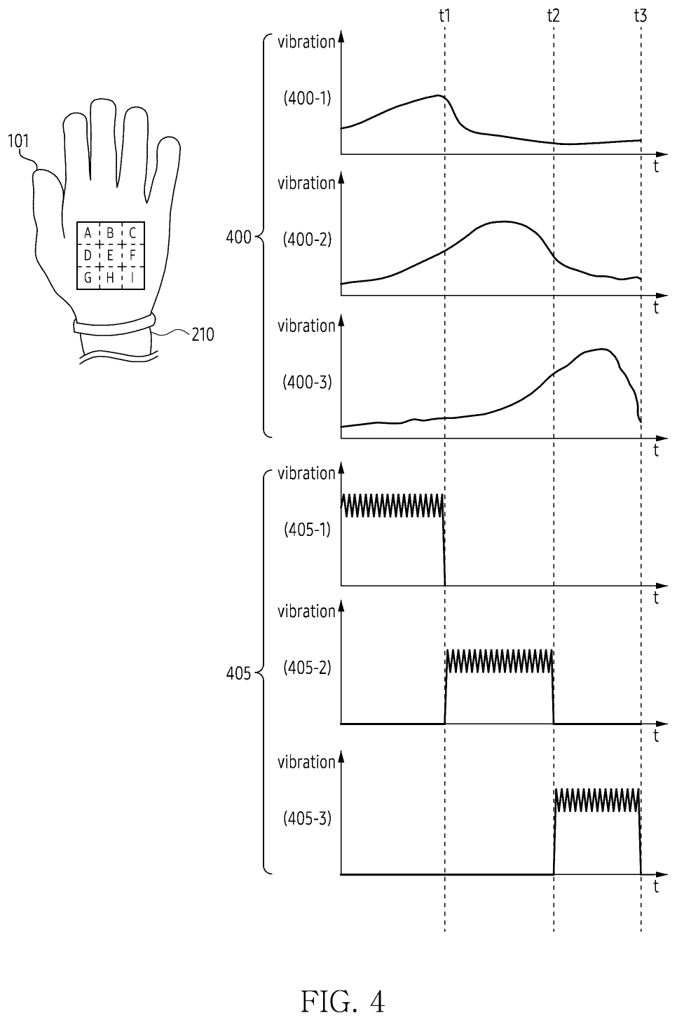

FIG. 4 is a diagram including graphs illustrating an example of an electronic device that outputs haptic data, according to various embodiments. An electronic device 101 of FIG. 4 may include the electronic device 101 of FIGS. 1A, 1B, 2 and/or 3. Operations of FIG. 4 may be executed by the processor 120 of FIG. 1A and/or 1B. FIG. 4 may include an example of the electronic device 101 worn on a body of a user 210 of the electronic device 101. However, the disclosure is not limited thereto.

Referring to FIG. 4, according to an embodiment, the electronic device 101 may include a plurality of heating elements and a plurality of haptic actuators, which are arranged on a housing. For example, the electronic device 101 may include a plurality of heating elements and a plurality of haptic actuators, which are arranged on areas A, B, C, D, E, F, G, H, and I. FIG. 4 may include a graph 400 related to a plurality of heating elements and the graph 405 related to a plurality of haptic actuators. The graphs 400 and 405 may be related to haptic feedback output by components disposed on the area D, the area E, and the area F. For example, a first graph 400-1 may be related to a plurality of heating elements disposed on the area D. For example, a second graph 400-2 may be related to a plurality of heating elements disposed on the area E. For example, a third graph 400-3 may be related to a plurality of heating elements disposed on the area F. For example, a fourth graph 405-1 may be related to a plurality of haptic actuators disposed on the area D. For example, a fifth graph 405-2 may be related to a plurality of haptic actuators disposed on the area E. For example, a sixth graph 405-3 may be related to a plurality of haptic actuators disposed on the area F.

According to an embodiment, the electronic device 101 may receive haptic data from an external electronic device. The electronic device 101 may control a plurality of heating elements and a plurality of haptic actuators, based on receiving the haptic data. For example, the electronic device 101 may identify an orientation indicated by the haptic data. The electronic device 101 may sequentially control a plurality of heating elements and a plurality of haptic actuators based on the orientation. For example, the electronic device 101 may control a plurality of heating elements disposed on the area D during a first time interval 410. For example, the electronic device 101 may control a plurality of haptic actuators disposed on the area D during the first time interval 410. For example, the electronic device 101 may control a plurality of heating elements disposed on the area E during a second time interval 420 after the first time period 410. For example, the electronic device 101 may control a plurality of haptic actuators disposed on the area E during the second time interval 420. For example, the electronic device 101 may control a plurality of heating elements disposed on the area F during a third time interval 430 after the second time interval 420. For example, the electronic device 101 may control a plurality of haptic actuators disposed on the area F during the third time interval 430. For example, the electronic device 101 may sequentially control a plurality of heating elements and a plurality of haptic actuators disposed on the area D to the area F during the first time interval 410 to the third time interval 430. Although different components have been illustrated as being controlled for each time interval, the components may be controlled at least temporarily and simultaneously.

As described above, according to an embodiment, the electronic device 101 may output haptic feedback based on haptic data. The electronic device 101 may control a plurality of heating elements and a plurality of haptic actuators based on an orientation indicated by the haptic data. The electronic device 101 may enhance a user experience of the electronic device 101 by controlling a plurality of heating elements and a plurality of haptic actuators based on the orientation.

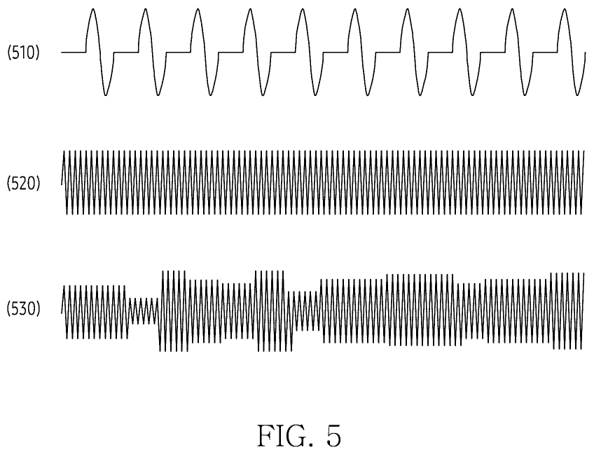

FIG. 5 is a diagram illustrating examples of haptic data, according to various embodiments. An electronic device 101 of FIG. 5 may include the electronic device 101 of FIGS. 1A, 1B, 2, 3, and/or 4. Operations of FIG. 5 may be executed by the processor 120 of FIG. 1A and/or 1B. A horizontal axis of a graph illustrated in FIG. 5 may refer, for example, to time. A vertical axis of the graph illustrated in FIG. 5 may refer, for example, to a voltage. However, the disclosure is not limited thereto.

Referring to FIG. 5, according to an embodiment, the electronic device 101 may receive haptic data for controlling a haptic actuator (e.g., the haptic actuator 180 of FIG. 1A and/or FIG. 1B). According to an embodiment, the electronic device 101 may identify haptic data stored in memory (e.g., the memory of FIG. 1A and/or FIG. 1B). For example, the haptic data may include haptic data for representing texture. An example of FIG. 5 may include an example of a frequency output by a haptic actuator included in the electronic device 101. For example, the electronic device 101 may receive, from an external electronic device, haptic data to adjust a frequency output by a haptic actuator. For example, the electronic device 101 may adjust a current and/or a voltage of the frequency.

According to an embodiment, the electronic device 101 may obtain haptic information for outputting haptic feedback synchronized with media content while outputting the media content. FIG. 5 may include an example of frequency waveforms of a first form 510, a second form 520 and a third form 530 (which may be referred to as the first form 510 to the third form 530) of FIG. 5. However, the disclosure is not limited thereto. The frequency waveforms of the first form 510 to the third form 530 may include a frequency waveform output by the haptic actuator. However, the disclosure is not limited thereto.

According to an embodiment, the electronic device 101 may output haptic data including a frequency waveform of the first form 510. For example, haptic data including the frequency waveform of the first form 510 may include haptic data for representing a smooth texture such as an ice cube. However, the disclosure is not limited thereto.

According to an embodiment, the electronic device 101 may output haptic data including a frequency waveform of the second form 520. For example, haptic data including the frequency waveform of the second form 520 may include haptic data for representing a regular and rough texture such as a surface of wood. However, the disclosure is not limited thereto.

According to an embodiment, the electronic device 101 may output haptic data including a frequency waveform of the third form 530. For example, haptic data including frequency waveforms of the third form 530 may include haptic data for representing an irregular and rough texture such as a rough sponge. However, the disclosure is not limited thereto.

As described above, according to an embodiment, the electronic device 101 may output haptic data for representing texture. The electronic device 101 may receive information associated with a visual object transmitted from an external electronic device. The electronic device 101 may output haptic data for representing a texture corresponding to the visual object, based on receiving information associated with the visual object. The electronic device 101 may enhance a user experience of the electronic device 101 by outputting haptic data for representing a texture corresponding to a visual object.

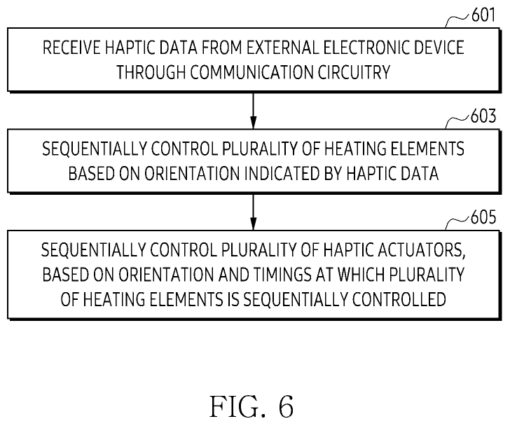

FIG. 6 is a flowchart illustrating an example operation of an electronic device, according to various embodiments. An electronic device of FIG. 6 may include the electronic device 101 of FIGS. 1A, 1B, 2, 3, 4, and/or 5. Operations of FIG. 6 may be executed by the processor 120 of FIG. 1A and/or 1B. The following operations may be performed sequentially, but are not necessarily performed sequentially. For example, a sequence of each operation may be changed, or at least two operations may be performed in parallel.

Referring to FIG. 6, in operation 601, according to an embodiment, the electronic device may receive haptic data from an external electronic device (e.g., the external electronic device 103 of FIG. 1A) through communication circuitry (e.g., the communication circuitry 160 of FIG. 1A). For example, the haptic data may be data for outputting haptic feedback. For example, the haptic data may include data for controlling a heating element (e.g., the heating element 170 of FIG. 1A and/or FIG. 1B) and/or a haptic actuator (e.g., the haptic actuator 180 of FIG. 1A and/or FIG. 1B), included within the electronic device. For example, the haptic data may include data associated with an orientation indicating a plurality of heating elements and a plurality of haptic actuators, controlled by the electronic device. For example, the haptic data may include data associated with a position where a plurality of heating elements and a plurality of haptic actuators arranged on a housing of the electronic device are controlled.

In operation 603, according to an embodiment, the electronic device may identify an orientation indicated by haptic data. The electronic device may control a plurality of heating elements based on the orientation indicated by the haptic data. For example, the electronic device may sequentially control the plurality of heating elements, based on the identification of the orientation. The electronic device may sequentially control, based on the haptic data, a plurality of heating elements arranged between a first point and a second point indicated by the haptic data.

In operation 605, according to an embodiment, the electronic device may control, e.g., sequentially, a plurality of haptic actuators, based on the orientation indicated by the haptic data and timings at which a plurality of heating elements is sequentially controlled. For example, the electronic device may control the plurality of haptic actuators corresponding to the plurality of heating elements. For example, the electronic device may control the plurality of haptic actuators at substantially the same timing as the plurality of heating elements. For example, the electronic device may control the plurality of haptic actuators corresponding to the plurality of heating elements within a preset time from a timing of controlling the plurality of heating elements.

According to an embodiment, the electronic device may identify first haptic data for controlling a plurality of heating elements included in haptic data. The electronic device may identify second haptic data for controlling a plurality of haptic actuators included in the haptic data. The electronic device may control the plurality of heating elements and the plurality of haptic actuators based on the first haptic data and the second haptic data. For example, the electronic device may output first haptic feedback corresponding to the first haptic data through the plurality of heating elements. The first haptic feedback may be associated with a temperature of a first heating element among the plurality of heating elements. For example, the electronic device may output second haptic feedback corresponding to the second haptic data through the plurality of haptic actuators. For example, the second haptic feedback may be associated with a first haptic actuator corresponding to the first heating element among the plurality of haptic actuators. For example, the second haptic feedback may be associated with intensity of a vibration generated by the first haptic actuator and/or a period of the vibration. For example, the second haptic feedback may be associated with haptic feedback for representing texture.

As described above, according to an embodiment, the electronic device may receive haptic data from an external electronic device. The electronic device may control, for example, sequentially a plurality of heating elements, based on an orientation indicated by the haptic data. The electronic device may control, for example, sequentially the plurality of haptic actuators, based on the orientation and timings at which the plurality of heating elements is sequentially controlled. The electronic device may control the plurality of heating elements and the plurality of haptic actuators at substantially the same timing. The electronic device may provide, to a user of the electronic device, complex haptic feedback, by controlling the plurality of heating elements and the plurality of haptic actuators at substantially the same timing. The electronic device may enhance a user experience of the electronic device, by outputting haptic feedback using the plurality of heating elements and the plurality of haptic actuators.

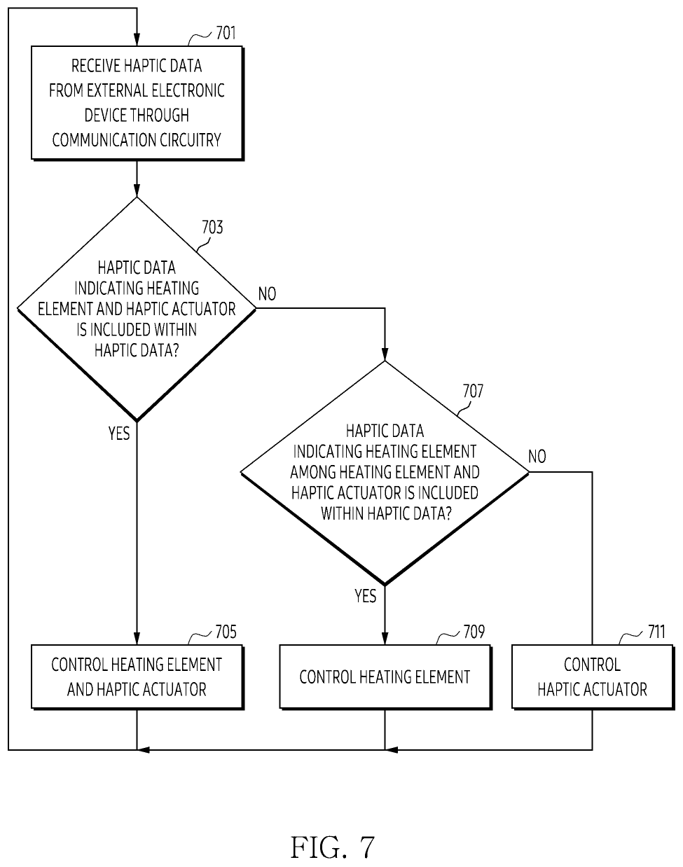

FIG. 7 is a flowchart illustrating an example operation of an electronic device, according to various embodiments. An electronic device of FIG. 7 may include the electronic device 101 of FIG. 1A, FIG. 1B, FIG. 2, FIG. 3, FIG. 4, and/or FIG. 5, and/or the electronic device of FIG. 6. Operations of FIG. 7 may be executed by the processor 120 of FIG. 1A and/or 1B. The following operations may be performed sequentially, but are not necessarily performed sequentially. For example, a sequence of each operation may be changed, or at least two operations may be performed in parallel.

Referring to FIG. 7, in operation 701, according to an embodiment, the electronic device may receive haptic data from an external electronic device (e.g., the external electronic device 103 of FIG. 1A) through communication circuitry (e.g., the communication circuitry 160 of FIG. 1A). For example, the haptic data may include haptic data described in FIG. 6. The electronic device may identify first haptic data for controlling a plurality of heating elements included in the haptic data. For example, the electronic device may identify second haptic data for controlling a plurality of haptic actuators included in the haptic data.

In operation 703, according to an embodiment, the electronic device may identify haptic data indicating a heating element and a haptic actuator within the haptic data. For example, the electronic device may identify whether haptic data indicating a heating element and a haptic actuator is included within haptic data. For example, the electronic device may identify haptic data indicating a plurality of heating elements including the heating element and a plurality of haptic actuators including the haptic actuator within the haptic data. For example, the electronic device may identify first haptic data and second haptic data.

When haptic data indicating a heating element and a haptic actuator is identified (operation 703—YES), in operation 705, according to an embodiment, the electronic device may control a heating element and a haptic actuator. For example, the electronic device may identify first haptic data and second haptic data included in the haptic data. The electronic device may control a heating element indicated by the first haptic data and a haptic actuator indicated by the second haptic data, based on the identification of the first haptic data and the second haptic data.

According to an embodiment, the electronic device may identify capability information of a heating element and a haptic actuator. The electronic device may change haptic data transmitted from an external electronic device, based on the capability information. For example, the electronic device may change the first haptic data indicating the heating element based on the capability information. For example, the electronic device may change the second haptic data indicating the haptic actuator based on the capability information.

When haptic data indicating a heating element and a haptic actuator is not identified (operation 703—NO), in operation 707, according to an embodiment, the electronic device may identify whether haptic data indicating a heating element among the heating element and a haptic actuator is included within haptic data. The electronic device may identify whether the first haptic data is identified among the first haptic data and the second haptic data included in the haptic data. According to an embodiment, the electronic device may identify haptic data indicating the heating element among the heating element and the haptic actuator, within the haptic data. For example, the electronic device may identify the first haptic data included in the haptic data.

When haptic data indicating the heating element among the heating element and the haptic actuator is identified within haptic data (operation 707—YES), in operation 709, according to an embodiment, the electronic device may control the heating element. For example, the electronic device may control the heating element, based on identifying haptic data indicating the heating element among the heating element and the haptic actuator within the haptic data. For example, the electronic device may control the heating element, based on identifying first haptic data among the first haptic data and second haptic data included in the haptic data.

According to an embodiment, the electronic device may identify capability information of the heating element. The capability information of the heating element may be associated with a temperature capable of being output by the heating element. The electronic device may change the first haptic data received from the external electronic device to correspond to the capability information of the heating element, based on the capability information of the heating element.

When haptic data indicating the haptic actuator among the heating element and the haptic actuator is identified within haptic data (operation 709-NO), according to an embodiment, the electronic device may control the haptic actuator. For example, the electronic device may control the haptic actuator, based on identifying haptic data indicating the haptic actuator among the heating element and haptic actuator within the haptic data. The electronic device may control the haptic actuator, based on identifying second haptic data among the first haptic data and the second haptic data included in the haptic data.

According to an embodiment, the electronic device may identify capability information of the haptic actuator. The capability information of the haptic actuator may be associated with haptic feedback capable of being output by the haptic actuator. The electronic device may change the second haptic data transmitted from the external electronic device to correspond to the capability information of the haptic actuator, based on the capability information of the haptic actuator.

As described above, according to an embodiment, the electronic device may receive haptic data from an external electronic device. The electronic device may identify first haptic data for indicating a heating element and second haptic data for indicating a haptic actuator, included in the haptic data. The electronic device may identify at least one of the first haptic data or the second haptic data. Based on identifying one of the first haptic data and the second haptic data, the electronic device may output haptic feedback associated with the identified haptic data. The electronic device may enhance a user experience of the electronic device by outputting haptic feedback using a component corresponding to the haptic data.

A method for outputting haptic feedback to enhance a user experience of an electronic device may be required.

As described above, according to an example embodiment, an electronic device may comprise: communication circuitry, a housing comprising a surface in which a plurality of heating elements and a plurality of haptic actuators are arranged, and at least one processor, comprising processing circuitry, coupled to the plurality of heating elements and the plurality of haptic actuators arranged on the surface. At least one processor, individually and/or collectively, may be configured to cause the electronic device to: receive, from an external electronic device through the communication circuitry, haptic data; control, based on an orientation indicated by the haptic data, the plurality of heating elements; and control, based on the orientation and timings at which the plurality of heating elements is controlled, the plurality of haptic actuators.

According to an example embodiment, at least one processor, individually and/or collectively, may be configured to: control, based on identifying that a temperature of a first heating element among the plurality of heating elements is a specified temperature, a first haptic actuator corresponding to the first heating element among the plurality of haptic actuators.

According to an example embodiment, at least one processor, individually and/or collectively, may be configured to: identify, based on receiving the haptic data, first haptic data to control the plurality of heating elements and second haptic data to control the plurality of haptic actuators included in the haptic data; and adjust, based on identifying the first haptic data and the second haptic data, the first haptic data or the second haptic data.

According to an example embodiment, the electronic device may comprise a memory. At least one processor, individually and/or collectively, may be configured to identify haptic information associated with the haptic data store in the memory.

According to an example embodiment, at least one processor, individually and/or collectively, may be configured to control, based on the haptic information, the plurality of heating elements and the plurality of haptic actuators.

According to an example embodiment, at least one processor, individually and/or collectively, may be configured to adjust, based on receiving the haptic data, a current and/or a voltage to control the plurality of haptic actuators.

According to an example embodiment, at least one processor, individually and/or collectively, may be configured to adjust, based on receiving the haptic data, a current and/or a voltage to control the plurality of heating elements.

According to an example embodiment, at least one processor, individually and/or collectively, may be configured to identify a first heating element and a second heating element among the plurality of heating elements; and control, based on controlling the first heating element, the second heating element within a specified time.

According to an example embodiment, at least one processor, individually and/or collectively, may be configured to, in a state of at least temporarily ceasing to control the plurality of heating elements among the plurality of heating elements and the plurality of haptic actuators, control the plurality of haptic actuators corresponding to the plurality of heating elements of which the controlling is ceased.

According to an example embodiment, at least one processor, individually and/or collectively, may be configured to, while controlling a first heating element among the plurality of heating elements, control a first haptic actuator corresponding to the first heating element; and while controlling a second heating element different from the first heating element, at least temporarily cease to control a second haptic actuator corresponding to the second heating element.

As described above, according to an example embodiment, a method of operating an electronic device may comprise: receiving, from an external electronic device through communication circuitry, haptic data; controlling, based on an orientation indicated by the haptic data, a plurality of heating elements; and controlling, based on the orientation and timings at which the plurality of heating elements is controlled, a plurality of haptic actuators.

According to an example embodiment, the method may comprise controlling, based on identifying that a temperature of a first heating element among the plurality of heating elements is a specified temperature, a first haptic actuator corresponding to the first heating element among the plurality of haptic actuators.

According to an example embodiment, the method may comprise: identifying, based on receiving the haptic data, first haptic data to control the plurality of heating elements and second haptic data to control the plurality of haptic actuators included in the haptic data; and adjusting, based on identifying the first haptic data and the second haptic data, the first haptic data or the second haptic data.

According to an example embodiment, the method may comprise identifying haptic information associated with the haptic data store in a memory.

According to an example embodiment, the method may comprise controlling, based on the haptic information, the plurality of heating elements and the plurality of haptic actuators.

According to an example embodiment, the method may comprise adjusting, based on receiving the haptic data, a current and/or a voltage to control the plurality of haptic actuators.

According to an example embodiment, the method may comprise adjusting, based on receiving the haptic data, a current and/or a voltage to control the plurality of heating elements.

According to an example embodiment, the method may comprise: identifying a first heating element and a second heating element among the plurality of heating elements; and controlling, based on controlling the first heating element, the second heating element within a specified time.

According to an example embodiment, the method may comprise: in a state of at least temporarily ceasing to control the plurality of heating elements among the plurality of heating elements and the plurality of haptic actuators, controlling the plurality of haptic actuators corresponding to the plurality of heating elements of which the controlling is ceased.

According to an example embodiment, the method may comprise: while controlling a first heating element among the plurality of heating elements, controlling a first haptic actuator corresponding to the first heating element; and while controlling a second heating element different from the first heating element, at least temporarily ceasing to control a second haptic actuator corresponding to the second heating element.

According to an example embodiment, a non-transitory computer-readable storage medium storing one or more programs, the one or more programs may, when executed by at least one processor, comprising processing circuitry, individually and/or collectively, of an electronic device, cause the electronic device to perform at least one operation comprising: receiving, from an external electronic device through communication circuitry, haptic data; control, based on an orientation indicated by the haptic data, a plurality of heating elements; and control, based on the orientation and timings at which the plurality of heating elements is sequentially, a plurality of haptic actuators.

According to an example embodiment, the at least one operation may include, based on identifying that a temperature of a first heating element among the plurality of heating elements is a specified temperature, a first haptic actuator corresponding to the first heating element among the plurality of haptic actuators 180.

According to an example embodiment, the at least one operation may include: based on receiving the haptic data, first haptic data to control the plurality of heating elements and second haptic data to control the plurality of haptic actuators included in the haptic data; and adjust, based on identifying the first haptic data and the second haptic data, the first haptic data or the second haptic data.

According to an example embodiment, the at least one operation may include identifying haptic information associated with the haptic data store in a memory.

According to an example embodiment, the at least one operation may include controlling, based on the haptic information, the plurality of heating elements 170 and the plurality of haptic actuators 180.

According to an example embodiment, the at least one operation may include adjusting, based on receiving the haptic data, a current and/or a voltage to control the plurality of haptic actuators.

According to an example embodiment, the at least one operation may include adjusting, based on receiving the haptic data, a current and/or a voltage to control the plurality of heating elements.

According to an example embodiment, the at least one operation may include: identifying a first heating element and a second heating element among the plurality of heating elements; and controlling, based on controlling the first heating element, the second heating element within a specified time.

According to an example embodiment, the at least one operation may include, in a state of at least temporarily ceasing to control the plurality of heating elements among the plurality of heating elements and the plurality of haptic actuators, controlling the plurality of haptic actuators corresponding to the plurality of heating elements of which the controlling is ceased.

According to an example embodiment, the at least one operation may include: while controlling a first heating element among the plurality of heating elements, controlling a first haptic actuator corresponding to the first heating element; and while controlling a second heating element different from the first heating element, at least temporarily ceasing to control a second haptic actuator corresponding to the second heating element.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

No claim element is to be construed under the provisions of 35 U.S.C. § 112, sixth paragraph, unless the element is expressly recited using the phrase “means for” or “means.”

What is claimed is:

1. An electronic device comprising:
communication circuitry;
a housing comprising a surface in which a plurality of heating elements and a plurality of haptic actuators are arranged;
memory comprising one or more storage media storing instructions; and
at least one processor comprising processing circuitry, wherein the instructions, when executed by at least one processor individually and/or collectively, cause the electronic device to:
receive, from an external electronic device through the communication circuitry, haptic data;
control, based on an orientation indicated by the haptic data, the plurality of heating elements; and
control, based on the orientation and timings at which the plurality of heating elements is controlled, the plurality of haptic actuators.

2. The electronic device of claim 1, wherein the instructions, when executed by at least one processor individually and/or collectively, cause the electronic device to:
control, based on identifying that a temperature of a first heating element among the plurality of heating elements is a specified temperature, a first haptic actuator corresponding to the first heating element among the plurality of haptic actuators.

3. The electronic device of claim 1, wherein the instructions, when executed by at least one processor individually and/or collectively, cause the electronic device to:
identify, based on receiving the haptic data, first haptic data to control the plurality of heating elements and second haptic data to control the plurality of haptic actuators included in the haptic data; and
adjust, based on identifying the first haptic data and the second haptic data, the first haptic data or the second haptic data.

4. The electronic device of claim 1, wherein the instructions, when executed by at least one processor individually and/or collectively, cause the electronic device to:
identify haptic information associated with the haptic data stored in the memory.

5. The electronic device of claim 4, wherein the instructions, when executed by at least one processor individually and/or collectively, cause the electronic device to:
control, based on the haptic information, the plurality of heating elements and the plurality of haptic actuators.

6. The electronic device of claim 1, wherein the instructions, when executed by at least one processor individually and/or collectively, cause the electronic device to:
adjust, based on receiving the haptic data, a current and/or a voltage to control the plurality of haptic actuators.

7. The electronic device of claim 1, wherein the instructions, when executed by at least one processor individually and/or collectively, cause the electronic device to:
adjust, based on receiving the haptic data, a current and/or a voltage to control the plurality of heating elements.

8. The electronic device of claim 1, wherein the instructions, when executed by at least one processor individually and/or collectively, cause the electronic device to:
identify a first heating element and a second heating element among the plurality of heating elements; and
control, based on controlling the first heating element, the second heating element within a specified time.

9. The electronic device of claim 1, wherein the instructions, when executed by at least one processor individually and/or collectively, cause the electronic device to:
in a state of at least temporarily ceasing to control the plurality of heating elements among the plurality of heating elements and the plurality of haptic actuators, control the plurality of haptic actuators corresponding to the plurality of heating elements of which the controlling is ceased.

10. The electronic device of claim 1, wherein the instructions, when executed by at least one processor individually and/or collectively, cause the electronic device to:
while controlling a first heating element among the plurality of heating elements, control a first haptic actuator corresponding to the first heating element; and
while controlling a second heating element different from the first heating element, at least temporarily cease to control a second haptic actuator corresponding to the second heating element.

11. A method of operating an electronic device, comprising:
receiving, from an external electronic device through communication circuitry, haptic data;
controlling, based on an orientation indicated by the haptic data, a plurality of heating elements; and
controlling, based on the orientation and timings at which the plurality of heating elements is controlled, a plurality of haptic actuators.

12. The method of claim 11, further comprising:
controlling, based on identifying that a temperature of a first heating element among the plurality of heating elements is a specified temperature, a first haptic actuator corresponding to the first heating element among the plurality of haptic actuators.

13. The method of claim 11, further comprising:
identifying, based on receiving the haptic data, first haptic data to control the plurality of heating elements and second haptic data to control the plurality of haptic actuators included in the haptic data; and
adjusting, based on identifying the first haptic data and the second haptic data, the first haptic data or the second haptic data.

14. The method of claim 11, further comprising:
identifying haptic information associated with the haptic data stored in a memory.

15. The method of claim 14, further comprising:
controlling, based on the haptic information, the plurality of heating elements and the plurality of haptic actuators.

16. The method of claim 11, further comprising:
adjusting, based on receiving the haptic data, a current and/or a voltage to control the plurality of haptic actuators.

17. The method of claim 11, further comprising:
adjusting, based on receiving the haptic data, a current and/or a voltage to control the plurality of heating elements.

18. The method of claim 11, further comprising:
identifying a first heating element and a second heating element among the plurality of heating elements; and
controlling, based on controlling the first heating element, the second heating element in a specified time.

19. The method of claim 11, further comprising:
in a state at least temporarily ceasing controlling the plurality of heating elements among the plurality of heating elements or the plurality of haptic actuators, controlling the plurality of haptic actuators corresponding to the plurality of heating elements of which the controlling is ceased.

20. The method of claim 11, further comprising:
controlling, while controlling a first heating element among the plurality of heating elements, a first haptic actuator corresponding to the first heating element; and
at least temporarily ceasing, while controlling a second heating element different from the first heating element, controlling of a second haptic actuator corresponding to the second heating element.
